(19) United States
(12) Patent Application Publication
(10) Pub. No.: US 2003/0140332 A1
(43) Pub. Date: Jul. 24, 2003

(54) Method and apparatus for generating a software development tool

(76) Inventors: Jeffrey B. Norton, Pleasanton, CA (US); James A. Dibble, San Francisco, CA (US)

Correspondence Address: ROSENTHAL & OSHA L.L.P., 1221 MCKINNEY AVENUE, SUITE 2800, HOUSTON, TX, 77010, US

(21) Appl. No.: 10/036,738

(22) Filed: Dec. 21, 2001

(51) Int. Cl. G06F 9/44

(52) U.S. Cl. 717/106; 717/100

(57) ABSTRACT

A method for generating a software development tool, including creating a definition file defining an action to be performed by the software development tool, creating a schema defining characteristics of a plurality of desired inputs for the software development tool, creating a resource file comprising information required by the software development tool at runtime, and generating the software development tool using the definition file, the schema, and the resource file.

### BACKGROUND OF INVENTION

Automatic code generation is becoming increasingly common in the software development lifecycle. The need for automatic code generation has resulted from the increasing complexity of applications and the acceptance of various standard and de facto standard application programming interfaces (APIs). For example, Java™ contains many APIs that software developers regard as de facto standard. The complexity of these APIs ranges from simple core Java™ APIs found in Java™ 2 Standard Edition to complex APIs used for specialized applications such as Java™ Media Framework. Automatic code generation tools allow developers to efficiently develop and integrate simple and complex APIs into new software products. Further, automatic code generation tools automate the process of typically tedious and error-prone coding tasks.

Automatic code generation tools are typically specialized to produce a particular entity, e.g., an Extensible Markup Language (XML) document, an Enterprise JavaBean (EJB), etc. For example, Forte™ for Java™ is an integrated development environment (IDE) capable of creating Enterprise JavaBeans. Forte™ for Java™ contains productivity tools such as a graphical user interface, various wizards, etc. to aid in the development process. A wizard is an interactive help utility within an application that guides the developer through each step of a particular task, such as entering properties of a desired EJB. As new APIs are developed and/or new capabilities are desired, new specialized automatic code generation tools will need to be developed.

### SUMMARY OF INVENTION

In general, in one aspect, the invention relates to a method for generating a software development tool, comprising creating a definition file defining an action to be performed by the software development tool, creating a schema defining characteristics of a plurality of desired inputs for the software development tool, creating a resource file comprising information required by the software development tool at runtime, and generating the software development tool using the definition file, the schema, and the resource file.

In general, in one aspect, the invention relates to a method for generating a software development tool, including creating a definition file defining an action to be performed by the software development tool, creating a schema defining characteristics of a plurality of desired inputs for the software development tool, creating a resource file comprising information required by the software development tool at runtime, creating a command list comprising a set of commands that are used to define the action, generating the software development tool using the definition file, the schema, and the resource file, and generating an annotation defining custom characteristics of a user interface of the software development tool using the schema.

In general, in one aspect, the invention relates to a method for generating a software development tool, comprising creating a definition file defining an action to be performed by the software development tool, creating a schema defining characteristics of a plurality of desired inputs for the software development tool, creating a resource file comprising information required by the software development tool at runtime, creating a command list comprising a set of commands that are used to define the action, creating an annotation defining semantics of a graphical user interface of the software development tool, and generating the software development tool using the definition file, the schema, the, annotation, and the resource file.

In general, in one aspect, the invention relates to a computer-readable medium having recorded thereon instructions executable by a processor, the instructions for receiving a definition file defining an action to be performed by the software development tool, receiving a schema defining characteristics of a plurality of desired inputs for the software development tool, receiving a resource file comprising information required by the software development tool at runtime, and generating the software development tool using the definition file, the schema, and the resource file.

In general, in one aspect, the invention relates to a computer system to generate a software development tool, comprising a processor, a memory, an input means, a display device, and instructions stored in the memory for enabling the computer system under control of the processor, to perform: receiving a definition file defining an action to be performed by the software development tool, receiving a schema defining characteristics of a plurality of desired inputs for the software development tool, receiving a resource file comprising information required by the software development tool at runtime, receiving a command list comprising a set of commands that are used to define the action, generating the software development tool using the definition file, the schema, and the resource file, and generating an annotation defining custom characteristics of a user interface of the software development tool using the schema.

In general, in one aspect, the invention relates to a computer system to generate a software development tool, comprising a processor, a memory, an input means, a display device, and software instructions stored in the memory for enabling the computer system under control of the processor, to perform: receiving a definition file defining an action to be performed by the software development tool, receiving a schema defining characteristics of a plurality of desired inputs for the software development tool, receiving a resource file comprising information required by the software development tool at runtime, receiving a command list comprising a set of commands that are used to define the action, receiving an annotation defining semantics of a graphical user interface of the software development tool, generating the software development tool using the definition file, the schema, the annotation, and the resource file.

In general, in one aspect the invention relates to an apparatus for generating a software development tool, comprising means for creating a definition file defining an action to be performed by the software development tool, means for creating a schema defining characteristics of a plurality of desired inputs for the software development tool, means for creating a resource file comprising information required by the software development tool at runtime, means for creating a command list comprising a set of commands that are used to define the action, means for generating the software development tool using the definition file, the schema, and the resource file, and means for generating an annotation defining custom characteristics of a user interface of the software development tool using the schema.

In general, in one aspect, the invention relates to an apparatus for generating a software development tool, comprising means for creating a definition file defining an action to be performed by the software development tool, means for creating a schema defining characteristics of a plurality of desired inputs for the software development tool, means for creating a resource file comprising information required by the software development tool at runtime, means for creating a command list comprising a set of commands that are used to define the action, means for creating an annotation defining semantics of a graphical user interface of the software development tool, and means for generating the software development tool using the definition file, the schema, the annotation, and the resource file.

Other aspects and advantages of the invention will be apparent from the following description and the appended claims.

### BRIEF DESCRIPTION OF DRAWINGS

FIG. 1 illustrates a typical computer.

FIG. 2 illustrates a flow diagram for a software development tool generator in accordance with one embodiment of the invention.

FIG. 3 illustrates a software development tool generator integrated within an Integrated Development Environment in accordance with one embodiment of the invention.

FIG. 4 illustrates a “Choose Name” panel in accordance with one embodiment of the invention.

FIG. 5 illustrates a “Specify Session Property” panel in accordance with one embodiment of the invention.

FIG. 6 illustrates a software development tool integrated within an Integrated Development Environment in accordance with one embodiment of the invention.

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The present invention relates to a method for generating a specialized software development tool. Further, the present invention relates to using a definition file, a schema, and a resource file to generate the software development tool. Further, the present invention relates to generating a software development tool with a user interface.

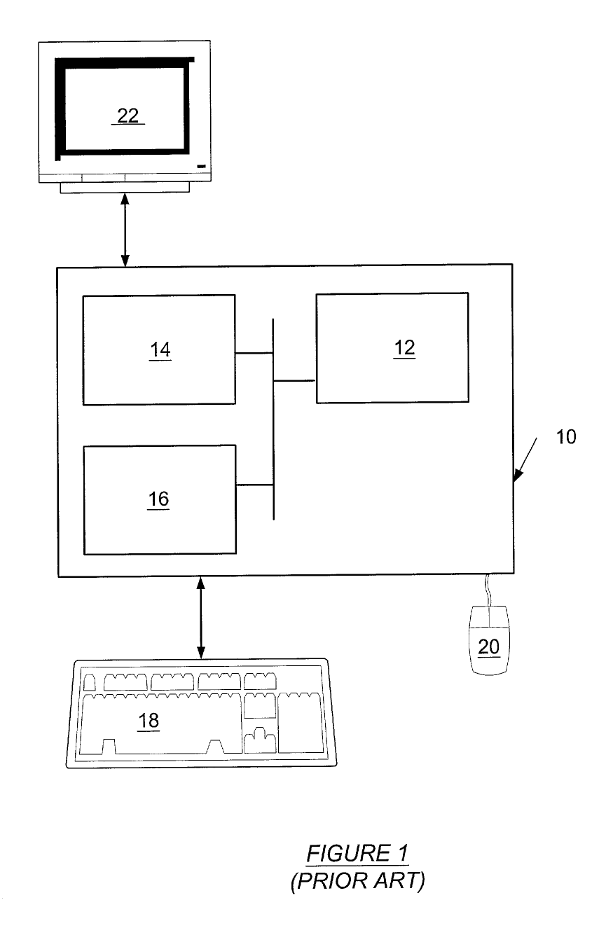

The present invention may be implemented on virtually any type computer regardless of the platform being used. For example, as shown in FIG. 1, a typical computer (10) includes a processor (12), associated memory (14), a storage device (16), and numerous other elements and functionalities typical of today's computers (not shown). The computer (10) may also include input means, such as a keyboard (18) and a mouse (20), and output means, such as a monitor (22). Those skilled in the art will appreciate that these input and output means may take other forms in an accessible environment.

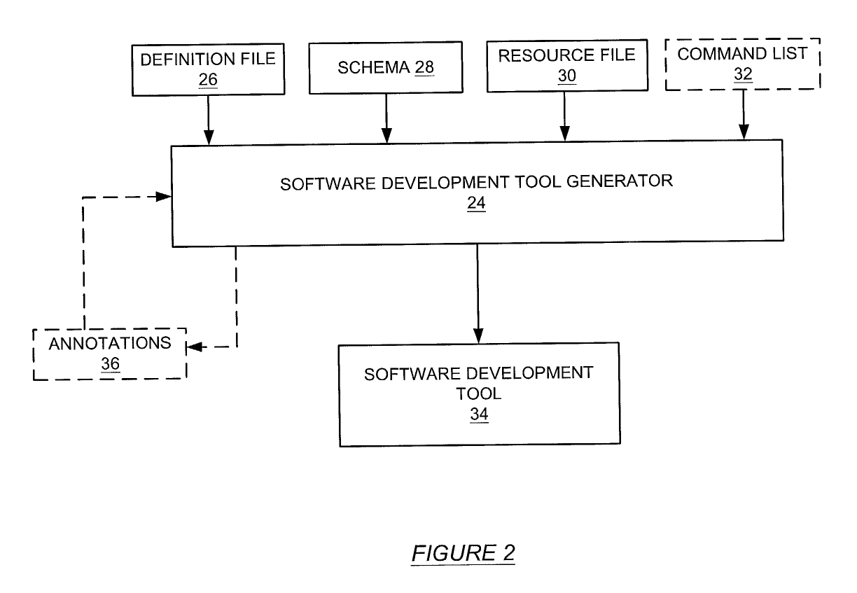

FIG. 2 illustrates a flow diagram for a software development tool generator in accordance with one embodiment of the invention. The software development tool generator (SDTG) (24) takes a definition file (26), a schema (28), and a resource file (30) as inputs, and generates a software development tool (SDT) (34).

The definition file (26) references all required files necessary for building the SDT (34). In one embodiment of the invention, the definition file is an XML document. Further, the definition file defines actions that the tool may perform.

In one embodiment, the definition file includes 7 elements: <Name>, <General>, <Source>, <Metadata>, <UserInterface>, <Runtime>, and <Action Definition>. The <Name> element contains the name of the tool that the SDTG (24) produces. The <General> element contains information of general relevance such as the version of the SDT (34), a short description of the SDT (34), and a long description of the SDT (34).

The <Source> element contains references to other files that serve as input to the SDTG (24), as well as describes general outputs. The <Source> element includes a number of sub-elements. The sub-elements may include, but are not limited to: a <JavaPackage> sub-element, a <SchemaFile> sub-element, an <AnnotationsFile> sub-element, a <ResourceFile> sub-element, and a <PropertyFile> sub-element. The <AnnotationsFile> and <ResourceFile> sub-elements are optional. The <ResourceFile> sub-element may be included multiple times. The <JavaPackage> sub-element identifies the Java™ package that is to contain all the Java™ source code generated for the SDT (34). The <SchemaFile> sub-element identifies the file that contains the schema (28). The schema (28) describes the input that the SDT (34) collects to generate a desired entity. The <AnnotationsFile> sub-element identifies the file that contains the annotations (36). The annotations (36) are a formal mechanism allowing the user to declare and/or customize the user interface of the SDT (34). In one embodiment, the SDTG (24) initially generates the annotations (36) and subsequently provides access to them such that the user may customize the user interface of the SDT (34). In another embodiment of the invention, the annotations (36) are generated by the user and input into the SDTG (34). The <ResourceFile> identifies files that are required by the SDT (34) at runtime. The <PropertyFile> sub-element includes functionality to support internationalization, localization, and accessibility. In one embodiment of the invention, the user of the SDTG (24) provides the <PropertyFile>. In another embodiment of the invention, the SDTG (24) generates the <PropertyFile>.

Referring back to the definition file (26), the <Metadata> element identifies files that contain metadata default values for input specified in the schema (28). Metadata is an internal representation of data collected from the user used by the SDTG (24). In one embodiment of the invention, metadata is represented using Extensible Mark-up Language (XML). The metadata default values are consistent with the schema (28). The <UserInterface> element describes how the SDT's (34) functionality is made available within the user interface of the SDT (34). For example, the <UserInterface> element may specify that a specific functionality may only be accessible through a toolbar. The <Runtime> element describes the semantics of the runtime environment. The <ActionDefinition> element describes actions that the SDT (34) may perform. If the SDT (34) is to perform multiple actions, then each action is defined. The actions are defined in terms of a series of pre-defined commands. For example, an action may contain an <Ant> command followed by a <Transform> command. Where the <Ant> command processes input using an Ant script, the result is then passed to the <Transform> command which subsequently applies an Extensible Stylesheet Language Transformation (XSLT) to produce a desired entity.

The following code illustrates an exemplary definition file, in accordance with the embodiment described above.

Code Sample 1. Definition File

| | |
|---|---|
| 1 | <?xml version=“1.0” encoding=“UTF-8”?> |
| 2 | <DefinitionFile> |
| 3 | <Name>SessionEJBGenerator</Name> |

| | |
|---|---|
| 4 | <General> |

| | |
|---|---|
| 5 | <Version>1.0</Version> |
| 6 | <ShortDescrpt> Generates EJBs </ShortDescrpt> |
| 7 | <LongDescrpt>Collects the data to generate EJBs</LongDescrpt> |

| | |
|---|---|
| 8 | </General> |

| | |
|---|---|
| 9 | <Source> |

| | |
|---|---|
| 10 | <JavaPackage>com.sun.forte4j.session</JavaPackage> |
| 11 | |
| 12 | <Directory>gen</Directory> |
| 13 | <SchemaFile>session.xsd</SchemaFile> |
| 14 | <AnnotationsFile/> |
| 15 | <PropertyFile>Bundle.properties</PropertyFile> |
| 16 | <ResourceFile>bean.xsl</ResourceFile> |
| 17 | <ResourceFile>home.xsl</ResourceFiie> |
| 18 | <ResourceFile>remote.xsl</ResourceFile> |
| 19 | <ResourceFile>sesejb.xsl</ResourceFile> |
| 20 | <ResourceFile>ejbdd.xsl</ResourceFile> |

| | |
|---|---|
| 21 | </Source> |
| 22 | <Metadata> |

| | |
|---|---|
| 23 | <Extension>ses</Extension> |
| 24 | <Default> |

| | |
|---|---|
| 25 | <ResourceFile>SessionEJBGenerator.ses</ResourceFile> |

| | |
|---|---|
| 26 | </Default> |
| 27 | <RootElement>Session</RootElement> |
| 28 | <ReplacementRootElement>/</ReplacementRootElement> |

| | |
|---|---|
| 29 | </Metadata> |
| 30 | <UserInterface> |

| | |
|---|---|
| 31 | <DisplayName>Session EJB Generation Module</DisplayName> |
| 32 | <Description>Creates Session EJBs</Description> |
| 33 | <Category>J2EE Tools</Category> |
| 34 | <ExplorerNode> |

| | |
|---|---|
| 35 | <Icon> |

| | |
|---|---|
| 36 | <ResourceFile>SessionEJBDataIcon.gif</ResourceFile> |

| | |
|---|---|
| 37 | </Icon> |
| 38 | <ContextMenu> |

| | |
|---|---|
| 39 | <Action> |

| | |
|---|---|
| 40 | <Name>Generate</Name> |
| 41 | <LabelKey>LBL_Action_Generate</LabelKey> |
| 42 | <Shortcut/> |

| | |
|---|---|
| 43 | </Action> |
| 44 | <Separator/> |
| 45 | <Folder> |

| | |
|---|---|
| 46 | <Name>Tools</Name> |
| 47 | <Action> |

| | |
|---|---|
| 48 | <Name>Build</Name> |
| 49 | <LabelKey>LBL_Action_Build</LabelKey> |
| 50 | <Shortcut/> |

| | |
|---|---|
| 51 | </Action> |
| 52 | <Separator/> |

| | |
|---|---|
| 53 | </Folder> |

| | |
|---|---|
| 54 | </ContextMenu> |

| | |
|---|---|
| 55 | </ExplorerNode> |
| 56 | <Toolbar> |

| | |
|---|---|
| 57 | <Name>Build</Name> |
| 58 | <Action> |

| | |
|---|---|
| 59 | <Name>Generate</Name> |
| 60 | <LabelKey>LBL_Action_Generate</LabelKey> |
| 61 | <Icon> |

| | |
|---|---|
| 62 | <ResourceFile>SessionEJBDataIcon.gif</ResourceFile> |

| | |
|---|---|
| 63 | </Icon> |

| | |
|---|---|
| 64 | </Action> |
| 65 | <Separator/> |
| 66 | <Action> |

| | |
|---|---|
| 67 | <Name>Build</Name> |
| 68 | <LabelKey>LBL_Action_Build</LabelKey> |

| | |
|---|---|
| 69 | </Action> |

| | |
|---|---|
| 70 | </Toolbar> |

| | |
|---|---|
| 71 | <Menu> |

| | |
|---|---|
| 72 | <Name>Tools</Name> |
| 73 | <Action> |

| | |
|---|---|
| 74 | <Name>Generate</Name> |
| 75 | <LabelKey>LBL_Action_Generate</LabelKey> |
| 76 | <Shortcut<\hat{ }G</Shortcut> |

| | |
|---|---|
| 77 | </Action> |
| 78 | <Folder> |

| | |
|---|---|
| 79 | <Name>ISV Tools</Name> |

| | |
|---|---|
| 80 | <Action> |

| | |
|---|---|
| 81 | <Name>Generate</Name> |
| 82 | <LabelKey>LBL_Action_Generate</LabelKey> |
| 83 | <Shortcut>\hat{ }G</Shortcut> |

| | |
|---|---|
| 84 | </Action> |

| | |
|---|---|
| 85 | </Folder> |

| | |
|---|---|
| 86 | </Menu> |

| | |
|---|---|
| 87 | </UserInterface> |

| | |
|---|---|
| 88 | <Runtime> |

| | |
|---|---|
| 89 | <Logger> |

| | |
|---|---|
| 90 | <MessagePrefix>SessionEJB: </MessagePrefix> |
| 91 | <DefaultSetting>*:*</DefaultSetting> |

| | |
|---|---|
| 92 | </Logger> |

| | |
|---|---|
| 93 | <Classpath/> |

| | |
|---|---|
| 94 | <DependentModules/> |

| | |
|---|---|
| 95 | </Runtime> |

| | |
|---|---|
| 96 | <ActionDefinition> |

| | |
|---|---|
| 97 | <Name>Generate</Name> |
| 98 | |

| | |
|---|---|
| 99 | <Command><Transform> |

| | |
|---|---|
| 100 | <TransformFile><Name>sesejb.xsl</Name></TransformFile> |
| 101 | <OutputFile><Name><xsl:value-of select=“translate |
| 102 | (Session/Package,'.', '/') ”/>/<xsl:value-of |

| | |
|---|---|
| 103 | select=“Session/EjbName”/>.sesejb</Name></OutputFile> |

| | |
|---|---|
| 104 | </Transform></Command> |
| 105 | |
| 106 | <Command><Transform> |
| 107 | <TransformFile><Name>ejbdd.xsl</Name></TransformFile> |
| 108 | <OutputFile><Name><xsl:value-of select=“translate |

| | |
|---|---|
| 109 | (Session/Package,'.', '/') ”/>/<xsl:value-of |

| | |
|---|---|
| 110 | select=“Session/EjbName/>.ejbdd</Name></OutputFile> |

| | |
|---|---|
| 111 | </Transform></Command> |
| 112 | |
| 113 | <Command><Transform> |
| 114 | <TransformFile><Name>bean.xsl</Name></TransformFile> |

| | |
|---|---|
| 115 | <OutputFile><Name><xsl:value-of select=“translate |
| 116 | (Session/Package,'.', '/') ”/>/<xsl:value-of |

| | |
|---|---|
| 117 | select=“Session/EjbName”/>EJB.java</Name></OutputFile> |

| | |
|---|---|
| 118 | </Transform></Command> |
| 119 | |

| | |
|---|---|
| 120 | <Command><Transform> |
| 121 | <TransformFile><Name>home.xsl</Name></TransformFile> |
| 122 | <OutputFile><Name><xsl:value-of select=“translate |

| | |
|---|---|
| 123 | (Session/Package,'.', '/') ”/>/<xsl:value-of |

| | |
|---|---|
| 124 | select=“Session/EjbName”/>Home.java</Name></OutputFile> |

| | |
|---|---|
| 125 | </Transform></Command> |
| 126 | |

| | |
|---|---|
| 127 | <Command><Transform> |
| 128 | <TransformFile><Name>remote.xsl</Name></TransformFile> |
| 129 | <OutputFile><Name><xsl:value-of select=“translate(Session/Package, |

| | |
|---|---|
| 130 | '.', '/') ”/>/<xsl:value-of |
| 131 | select=“Session/EjbName”/>.java</Name></OutputFile> |

| | |
|---|---|
| 132 | </Transform></Command> |
| 133 | |

| | |
|---|---|
| 134 | </ActionDefinition> |

| | |
|---|---|
| 135 | </DefinitionFile> |

In the code listed above referred to as “Code Sample 1”, lines 4-8 define the properties of the <General> element. For example, the short description denoted as <ShortDescrpt> provides the following short description “Generates EJBs”.

Lines 9-21 define the properties of the <Source> element. In this particular example, the <Source> element lists a <SchemaFile> as session.xsd. Further, the <Source> element lists five <ResourceFiles>: beans.xsl, home.xsl, remote.xsl, sesjb.xsl, and ejbdd.xsl. Lines 22-29 define the properties of the <Metadata> element. For example, the file containing the default metadata values is SessionEJBGenerator.ses. Lines 30-87 define properties of the <UserInterface Element>. For example, the <UserInterface> element specifies that the action “Generate” is located in the “tool” menu and have a short cut of “\mathring{}G.” Lines 96-124 define the properties of the <ActionDefinition> element. In this example, there is only one action “Generate” that is defined as a series of transform commands. For example, the first <transform> command takes in the sesejb.xsl document as input and generates a .sesejb file as output.

Referring back to FIG. 2, the schema (28) defines the data to be collected from the user of the SDT (34) at runtime. Consider the following exemplary schema referenced by the definition file above.

Code Sample 2. Schema.xsd

| | |
|---|---|
| 1 | <?xml version=“1.0” encoding=“UTF-8”?> |
| 2 | <xsd:schema xmlns:xsd=“http://www.w3.org/2001/XMLSchema” |

| | |
|---|---|
| 3 | targetNamespace=“http://ejb.forte4j .sun.com” |
| 4 | xmlns=“http://ejb.forte4j .sun.com” |
| 5 | elementFormDefault=“qualified”> |

| | |
|---|---|
| 6 | <xsd:element name=“Session”> |

| | |
|---|---|
| 7 | <xsd:complexType> |

| | |
|---|---|
| 8 | <xsd:sequence> |

| | |
|---|---|
| 9 | <xsd:element name=“EjbName” type=“xsd:string”/> |
| 10 | <xsd:element name=“Package” type=“xsd:string”/> |
| 11 | <xsd:element name=“SessionType”> |

| | |
|---|---|
| 12 | <xsd:simpleType> |

| | |
|---|---|
| 13 | <xsd:restriction base=“xsd:string”> |

| | |
|---|---|
| 14 | <xsd:enumeration value=“Stateful”/> |
| 15 | <xsd:enumeration value=“Stateless”/> |

| | |
|---|---|
| 16 | </xsd:restriction> |

| | |
|---|---|
| 17 | </xsd:simpleType> |

| | |
|---|---|
| 18 | </xsd:element> |
| 19 | <xsd:element name=“TransactionType”> |

| | |
|---|---|
| 20 | <xsd:simpleType> |

| | |
|---|---|
| 21 | <xsd:restriction base=“xsd:string”> |

| | |
|---|---|
| 22 | <xsd:enumeration value=“Container”/> |
| 23 | <xsd:enumeration value=“Bean”/> |

| | |
|---|---|
| 24 | </xsd:restriction> |

| | |
|---|---|
| 25 | </xsd:simpleType> |

| | |
|---|---|
| 26 | </xsd:element> |
| 27 | <xsd:element name=“TransactionAttribute”> |

| | |
|---|---|
| 28 | <xsd:simpleType> |

| | |
|---|---|
| 29 | <xsd:restriction base=“xsd:string”> |

| | |
|---|---|
| 30 | <xsd:enumeration value=“Mandatory”/> |
| 31 | <xsd:enumeration value=“Never”/> |
| 32 | <xsd:enumeration value=“NotSupported”/> |
| 33 | <xsd:enumeration value=“Required”/> |
| 34 | <xsd:enumeration value=“RequiresNew”/> |
| 35 | <xsd:enumeration value=“Supports”/> |

| | |
|---|---|
| 36 | </xsd:restriction> |

| | |
|---|---|
| 37 | </xsd:simpleType> |

| | |
|---|---|
| 38 | </xsd:element> |

| | |
|---|---|
| 39 | </xsd:sequence> |

| | |
|---|---|
| 40 | </xsd:complexType> |

| | |
|---|---|
| 41 | </xsd:element> |

| | |
|---|---|
| 42 | </xsd:schema> |

Referring to the schema above referred to as “Code Sample 2”, line 9 defines a first required input “EjbName” and indicates that “EjbName” must be of type string. Line 10 defines a second required input “Package” and indicates that “Package” must also be of type string. Lines 11-17 define a third required input “SessionType.” Unlike the first and the second required input, the third required input may only have one of two possible values: “Stateful” or “Stateless.” Similarly, lines 19-26 define a fourth required input “TransactionType” which may only have one of two possible values: “Container” or “Bean.” Lines 27-38 define a fifth and final required input “TransactionAttribute.” The “TransactionAttribute” may have one of six possible values: “Mandatory”, “Never”, “NotSupported”, Required”, “RequiresNew”, and “Supports.” In one embodiment of the present invention, the schema (28) is represented as an XML document.

Referring back to FIG. 2, the resource file (30) contains data required by the SDT (34) at runtime. The resources files typically define how the data, input by the user of the SDT (34), is to be processed to produce the desired entity, e.g., an EJB. In one embodiment of the invention, the resource file (30) is an Extensible Stylesheet Language (XSL) document. In the particular case of an XSL document, the document defines transformations of the metadata stored in an XML format. Resource files (30) typically reference variables within the metadata using descriptors defined in the schema (28).

The following code illustrates a resource file (30) referenced by the definition file above.

Code Sample 3. Bean.xsl

| | |
|---|---|
| 1 | <?xml version=“1.0”?> |

| | |
|---|---|
| 2 | <xsl:transform xmlns:xsl=http://www.w3.org/1999/XSL/Transform |
| 3 | version=“1.0”> |
| 4 | <xsl:output method=“xml” indent=“yes”/> |
| 5 | <xsl:strip-space elements=“*”/> |
| 5 | |

| | |
|---|---|
| 6 | <xsl:template match=“Session”> |
| 7 | |
| 8 | <ejb-jar> |

| | |
|---|---|
| 9 | <enterprise-beans> |

| | |
|---|---|
| 10 | <session> |

| | |
|---|---|
| 11 | <description><xsl:value-of select=“EjbName”/> Session |
| 12 | Bean</description> |
| 13 | <display-name><xsl:value-of select=“EjbName”/></displayName> |
| 14 | <ejb-name><xsl:value-of select=“EjbName”/></ejb-name> |
| 15 | <home><xsl:value-of select=“Package“/>.<xsl:value-of |
| 16 | select=“EjbName”/>Home</home> |
| 17 | <remote><xsl:value-of select=“Package”/>.<xsl:value-of |
| 18 | select=“EjbName”/></remote> |
| 19 | <ejb-class><xsl:value-of select=“Package”/>.<xsl:value-of |
| 20 | select=“EjbName”/>EJB</ejb-class> |
| 21 | <session-type><xsl:value-of select=“SessionType”/></transaction-type> |
| 22 | <transaction-type><xsl:value-of |
| 23 | select=“TransactionType”/></transaction-type> |

| | |
|---|---|
| 24 | </session> |

| | |
|---|---|
| 25 | </enterprise-beans> |
| 26 | |
| 27 | <assembly-descriptor> |

| | |
|---|---|
| 28 | <container-transaction> |

| | |
|---|---|
| 29 | <method> |

| | |
|---|---|
| 30 | <ejb-name><xsl:value-of select=“EjbName”/></ejb-name> |
| 31 | <method-name>*</method-name> |

| | |
|---|---|
| 32 | </method> |
| 33 | <trans-attribute><xsl:value-of |
| 34 | select=“TransactionAttribte”/></trans-attribute> |

| | |
|---|---|
| 35 | </container-transaction> |

| | |
|---|---|
| 36 | </assembly-descriptor> |

| | |
|---|---|
| 37 | </ejb-jar> |
| 38 | |

| | |
|---|---|
| 39 | </xsl:template> |

| | |
|---|---|
| 40 | </xsl:transform> |

The resource file listed above, referred to as “Code Sample 3”, contains definitions for processing data received from the user of the SDT (34) and generating a portion of a desired entity. Specifically, in the resource file listed above, line 13 indicates that the display name for the EJB being generated should have the value of the “EjbName” input. Further, line 15 indicates that the home interface, denoted as <home>, should have the value of the “Package” input. Further, line 21 indicates that the session-type should have the value of the “SessionType” input. Further, line 23 indicates that the transaction-type should have the value of the “TransactionType” input. Finally, line 33 indicates that the trans-attribute should have the value of the “TransactionAttribute” input.

Referring to FIG. 2, the command list (32) defines a set commands that may be used in the definition file (26) to define the actions. In one embodiment of the invention, the command list (32) is provided to the SDTG (24) as an input. In another embodiment of the invention, the command list is coded into the SDTG (24). When the SDT (34) is generated by the SDTG (24), the SDT (34) contains the required functionality to interpret commands used within the <ActionDefinition>.

In one embodiment, each command within the command list (32) is defined with a required input and output. Further, the functionality to process each command is also specified. For example, the <Transform> command used in the definition file (refer to Code Sample 1, lines 96-134), listed above, uses a <TransformFile> parameter as input and an <Output> parameter to specify the location of the output of the command. In one embodiment of the invention, the <Transform> command initiates a Xalan™ Extensible Stylesheet Language Transformations (XSLT) processor that performs the transformations, specified in the <TransformFile>, upon the metadata collected from the user.

While only one specific command has been detailed, those skilled in the art will appreciate that other commands may be incorporated into the SDT (34). For example, the SDT (34) may contain functionality to execute an Ant script, copy and delete data, execute an external executable, invoke another action, execute a Java™ method, raise a dialogue to a user, etc.

In one embodiment of the invention, the SDTG (24) is a Java™ component that is run in a stand alone runtime environment.

In another embodiment of the present invention, the SDTG (24) is a module with an Integrated Development Environment (IDE), such as Forte™ for Java™.

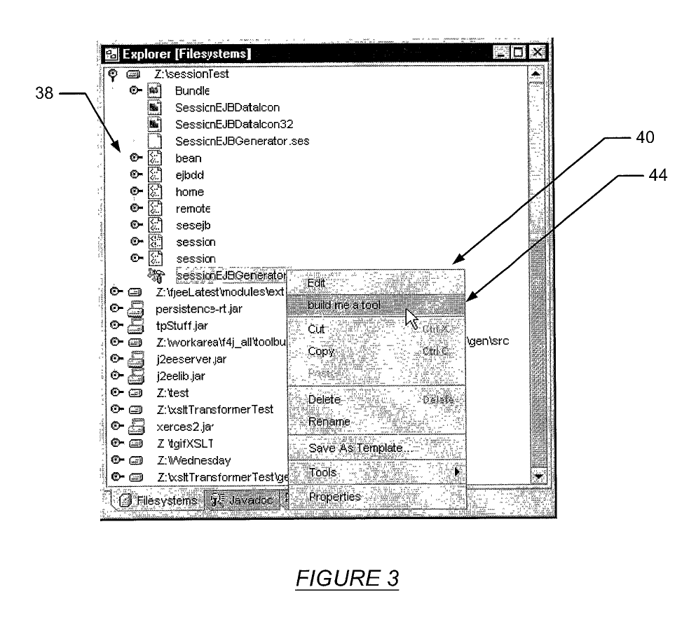

FIG. 3 illustrates a software development tool generator integrated within an Integrated Development Environment in accordance with one embodiment of the invention. In this particular example, the SDTG (24) is generating a “sessionEJBGenerator” tool and has been integrated into the File System (38). Additionally, the functionality of the SDTG (34) is included in the menu (40). Specifically, in this example, the menu option to generate the tool is “build me a tool” (42).

Once the SDT (34) has been generated, the user of the SDTG (34) may modify the source code or the annotations document prior to deploying the tool to an end user. This provides the user a means to customize the user interface of the tool by modifying the annotations, and a means to optimize the tool for a given platform or change its executable behavior by modifying the source code.

As shown in FIG. 2, the SDTG (24) generates a SDT (24) and Annotations (36). Annotations define how the information specified in the schema (28) is obtained from the user, i.e., the layout of the user interface to the tool, etc. In one embodiment of the invention, the annotations (36) are stored as an XML document. Further, the decisions regarding the means for obtaining information from the user, e.g., to use a text box versus a drop-down menu to obtain a particular piece of information, is typically coded into the annotations (36) by the SDTG (24). The following code illustrates exemplary annotations corresponding to the schema listed above (refer to Code Sample 2).

Code Sample 4. Annotations.xml

| | |
|---|---|
| 1 | <?xml version=“1.0”encoding=“UTF-8”?> |
| 2 | <ToolUI xmlns:xsd=http://www.w3.org/2001/XMLSchema |

| | |
|---|---|
| 3 | name=“SessionEJBGenerator”> |

| | |
|---|---|
| 4 | <Wizard name=“SessionEJBGeneratorWizard” xmlbean=“Session” label=“New |
| 5 | Session”> |

| | |
|---|---|
| 6 | <PanelRef ref=“targetChooser” built-in=“target” label=“Choose |

| | |
|---|---|
| 7 | Name”/> |

| | |
|---|---|
| 8 | <PanelRef ref=“SessionPanel” source=“.” multiplicity=“One” |

| | |
|---|---|
| 9 | xmlbean“Session” label=“Specify Session Properties”/> |

| | |
|---|---|
| 10 | </Wizard> |
| 11 | <Panel name=“SessionPanel” xmlbean=“Session” multiplicity”One=” |
| 12 | label=“Session Properties”> |

| | |
|---|---|
| 13 | <TextField name=“EjbNameField” source=“EjbName” label=“EjbName”/> |
| 14 | <TextField name=“PackageField” source=“Package” label=“Package”/> |
| 15 | <RadioPanel source=“SessionType” label=“SessionType”> |

| | |
|---|---|
| 16 | <Choice value=“Stateful” label=“Stateful”/> |
| 17 | <Choice value=“Stateless” label=“Stateless”/> |

| | |
|---|---|
| 18 | </RadioPanel> |
| 19 | <RadioPanel source=“TransactionType” label=“TransactionType”> |

| | |
|---|---|
| 20 | <Choice value=“Container” label=“Container”/> |
| 21 | <Choice value=“Bean” label=“Bean”/> |

| | |
|---|---|
| 22 | </RadioPanel> |
| 23 | <ComboBox source=“TransactionAttribute” |

| | |
|---|---|
| 24 | label=“TransactionAttribute”> |

| | |
|---|---|
| 25 | <Choice value=“Mandatory” label=“Mandatory”/> |
| 26 | <Choice value=“Never” label=“Never”/> |
| 27 | <Choice value=“NotSupported” label=“NotSupported”/> |
| 28 | <Choice value=“Required” label=“Required”/> |
| 29 | <Choice value=“RequiresNew” label=“RequiresNew”/> |
| 30 | <Choice value=“Supports” label=“Supports/> |

| | |
|---|---|
| 31 | </ComboBox> |

| | |
|---|---|
| 32 | </Panel> |

| | |
|---|---|
| 33 | </ToolUI> |

In the annotations document listed above referred to as “Code Sample 4”, lines 4-10 indicate that a wizard is used to obtain data from the user. Specifically, there are two panels: a “Choose Name” panel and a “Specify Session Properties” panel. Lines 11-31 detail how the various session property values are t obtained from the user. For example, line 13 indicated that the “EjbName” property is obtained using a TextField. Additionally, lines 15-18 indicate that the “SessionType” property is obtained using a RadioPanel. Further, lines 23-31 indicate that the “TransactionAttribute” property is to be obtained using a ComboBox.

In one embodiment of the invention, the SDT (34) is a Java™ component that is run in a stand alone runtime environment.

In another embodiment of the present invention, the SDT (34) is module with an Integrated Development Environment (IDE) such as Forte™ for Java™. In this particular example, the SDTG (24) has generated a tool to create EJBs using the “build me a tool command” (44 in FIG. 3). The user of the SDT (34) subsequently uses SDT (34) to generate an EJB.

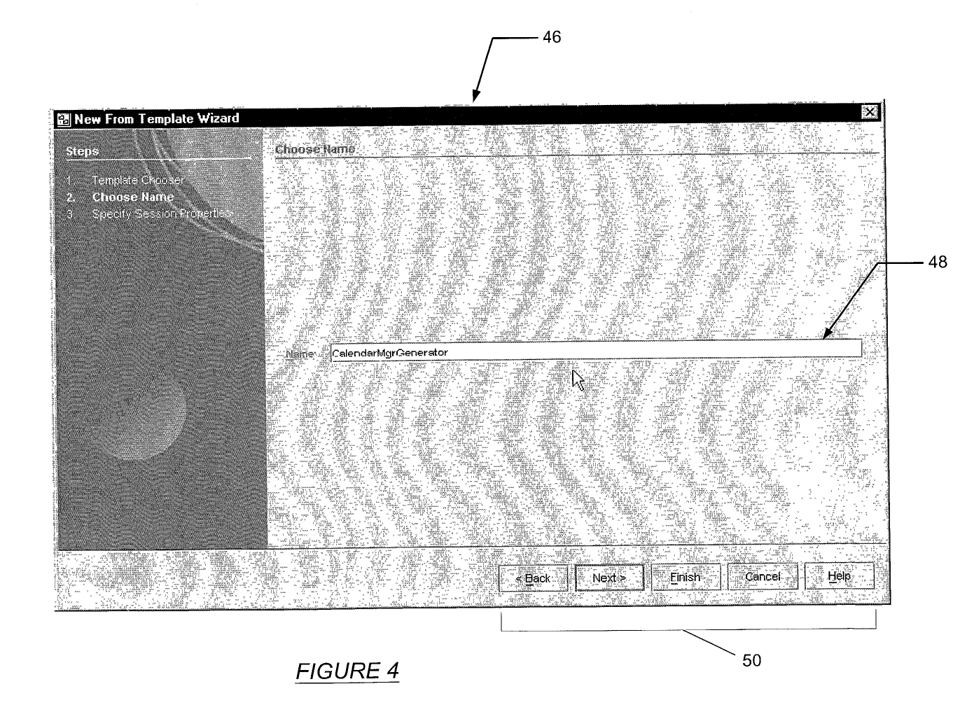

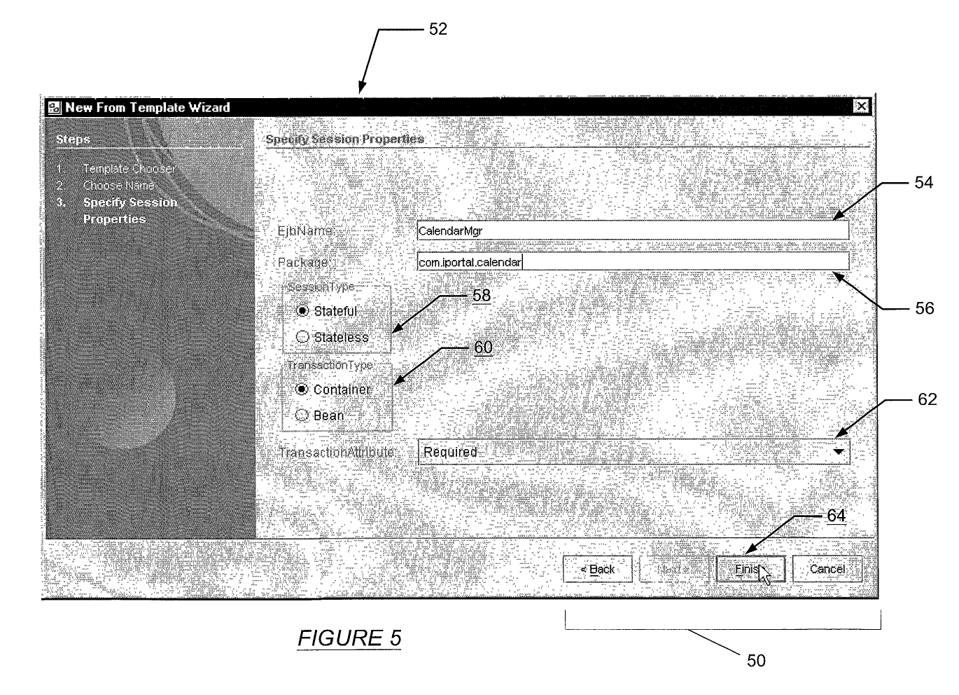

FIGS. 4 and 5 illustrate the wizard used to collect data to generate a desired EJB. FIG. 4 illustrates a “Choose Name” panel that is referenced above in the annotations document. The “Choose Name” panel (46) includes a textbox (48) to enter the name of the EJB to be generated. Further, the “Choose Name” panel contains a number of buttons for navigation (50).

FIG. 5 illustrates a “Specify Session Property” panel (52) that is referenced in the above annotations document. The “Specify Session Property” panel (52) includes a textbox (54) to enter the “EjbName”, a textbox (56) to enter the “Package”, a radio button panel (58) to specify the “SessionType”, a radio button panel (60) to specify the “TransactionType”, a combo box (62) to specify the “TransactionAttribute”, and a number of buttons for navigation (50). Once the user clicks the “Finish Button” (64). The information collected by the wizard from the end user is typically stored as metadata.

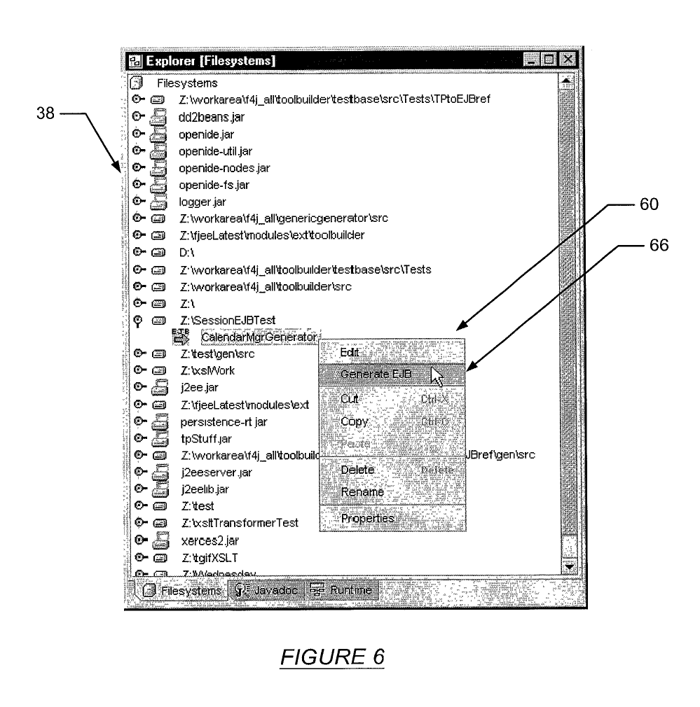

The end user may subsequently apply an action or multiple actions to the metadata using actions defined in the <ActionDefinition>. FIG. 6 illustrates a software development tool integrated within an Integrated Development Environment, in accordance with one embodiment of the invention. In this particular example, the EJB generator tool only has one action, “Generate EJB” (66), that is accessible via a pop-up menu (60). Once the user selects the “Generate EJB” action, the EJB generator tool applies the commands listed within the action to generate the desired entity.

The invention has one or more of the following advantages. The present invention allows new software development tools to be generated and deployed in a shorter time span. Further, the present invention allows software development companies to readily develop internal tools customized to their specific requirements. Further, the present invention allows a user to create a series of tools which are consistent across a given environment. Further, the present invention allows graphical user interfaces to be created from the schema without the need to write additional source code. Further, the present invention allows the definition of semantics of a software development tool to be done through a schema and definition file without the need to write additional source code.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating a software development tool, comprising:
creating a definition file defining an action to be performed by the software development tool;
creating a schema defining characteristics of a plurality of desired inputs for the software development tool;
creating a resource file comprising information required by the software development tool at runtime; and
generating the software development tool using the definition file, the schema, and the resource file.

2. The method of claim 1, further comprising:
creating a command list comprising a set of commands that are used to define the action.

3. The method of claim 1, further comprising:
generating an annotation defining custom characteristics of a user interface of the software development tool using the schema.

4. The method of claim 1, further comprising:
creating an annotation defining semantics of a graphical user interface of the software development tool, wherein the annotation is used with the definition file, the schema, and the resource file to generate the software development tool.

5. The method of claim 1, wherein the definition file further comprises references to the schema and the resource file.

6. The method of claim 2, wherein the definition file further comprises references to the schema, the resource file, and the command list.

7. The method of claim 3, wherein the definition file further comprises references to the schema, the resource file, and the annotation.

8. The method of claim 1, wherein the definition file comprises an Extensible Mark-up Language document.

9. The method of claim 1, wherein the schema comprises an Extensible Mark-up Language document.

10. The method of claim 1, wherein the resource file comprises an Extensible Stylesheet Language document.

11. The method of claim 2, wherein the command list comprises a transform command.

12. The method of claim 11, wherein the transform command initiates an Extensible Stylesheet Language processor.

13. The method of claim 1, wherein the annotation comprises an Extensible Mark-up Language document.

14. The method of claim 3, wherein data obtained by the user interface is stored as metadata.

15. The method of claim 14, wherein metadata comprises an Extensible Mark-up Language document.

16. The method of claim 1, wherein the action comprises commands.

17. The method of claim 1, wherein the software development tool is generated using a software development tool generator.

18. The method of claim 17, wherein the software development tool generator is integrated within an Integrated Development Environment.

19. The method of claim 1, wherein the software development tool is integrated within an Integrated Development Environment.

20. A method for generating a software development tool, comprising:
creating a definition file defining an action to be performed by the software development tool;
creating a schema defining characteristics of a plurality of desired inputs for the software development tool;
creating a resource file comprising information required by the software development tool at runtime;
creating a command list comprising a set of commands that are used to define the action;
generating the software development tool using the definition file, the schema, and the resource file; and
generating an annotation defining custom characteristics of a user interface of the software development tool using the schema.

21. A method for generating a software development tool, comprising:
creating a definition file defining an action to be performed by the software development tool;
creating a schema defining characteristics of a plurality of desired inputs for the software development tool;
creating a resource file comprising information required by the software development tool at runtime;
creating a command list comprising a set of commands that are used to define the action;
creating an annotation defining semantics of a graphical user interface of the software development tool; and
generating the software development tool using the definition file, the schema, the, annotation, and the resource file.

22. A computer-readable medium having recorded thereon instructions executable by a processor, the instructions for: receiving a definition file defining an action to be performed by the software development tool;
receiving a schema defining characteristics of a plurality of desired inputs for the software development tool;
receiving a resource file comprising information required by the software development tool at runtime; and
generating the software development tool using the definition file, the schema, and the resource file.

23. The computer-readable medium of claim 22, further comprising instructions for:
receiving a command list comprising a set of commands that are used to define the action; and
generating an annotation defining custom characteristics of a user interface of the software development tool using the schema.

24. The computer-readable medium of claim 22, further comprising instructions for:
receiving an annotation defining semantics of a graphical user interface of the software development tool, wherein the annotation is used with the definition file, the schema, and the resource file to generate the software development tool.

25. A computer system to generate a software development tool, comprising:
a processor;
a memory;
an input means;
a display device; and
instructions stored in the memory for enabling the computer system under control of the processor, to perform:
receiving a definition file defining an action to be performed by the software development tool;
receiving a schema defining characteristics of a plurality of desired inputs for the software development tool;
receiving a resource file comprising information required by the software development tool at runtime;
receiving a command list comprising a set of commands that are used to define the action;
generating the software development tool using the definition file, the schema, and the resource file; and
generating an annotation defining custom characteristics of a user interface of the software development tool using the schema.

26. A computer system to generate a software development tool, comprising:
a processor;
a memory;
an input means;
a display device; and
software instructions stored in the memory for enabling the computer system under control of the processor, to perform:
receiving a definition file defining an action to be performed by the software development tool;
receiving a schema defining characteristics of a plurality of desired inputs for the software development tool;
receiving a resource file comprising information required by the software development tool at runtime;
receiving a command list comprising a set of commands that are used to define the action;
receiving an annotation defining semantics of a graphical user interface of the software development tool;
generating the software development tool using the definition file, the schema, the annotation, and the resource file.

27. An apparatus for generating a software development tool, comprising:
means for creating a definition file defining an action to be performed by the software development tool;
means for creating a schema defining characteristics of a plurality of desired inputs for the software development tool;
means for creating a resource file comprising information required by the software development tool at runtime;
means for creating a command list comprising a set of commands that are used to define the action;
means for generating the software development tool using the definition file, the schema, and the resource file; and
means for generating an annotation defining custom characteristics of a user interface of the software development tool using the schema.

28. An apparatus for generating a software development tool, comprising:
means for creating a definition file defining an action to be performed by the software development tool;
means for creating a schema defining characteristics of a plurality of desired inputs for the software development tool;
means for creating a resource file comprising information required by the software development tool at runtime;
means for creating a command list comprising a set of commands that are used to define the action;
means for creating an annotation defining semantics of a graphical user interface of the software development tool; and
means for generating the software development tool using the definition file, the schema, the annotation, and the resource file.
